(19) United States
(12) Patent Application Publication
(10) Pub. No.: US 2006/0069727 A1
(43) Pub. Date: Mar. 30, 2006

(54) System and method for synchronizing between an instant messenger client and a central contact store

(75) Inventors: Deana R. Fuller, Seattle, WA (US); John Anthony Owens, Seattle, WA (US); Mark D. Coburn, Sammamish, WA (US); Paul R. Erickson, Sammamish, WA (US); Peyman Oreizy, Kirkland, WA (US); Sean O. Blagsvedt, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/926,886

(22) Filed: Aug. 25, 2004

(51) Int. Cl. G06F 15/16

(52) U.S. Cl. 709/206

(57) ABSTRACT

Contacts and associated presence information for contacts of an instant messenger (IM) application are synchronized with a centralized contact store within a file system of a computing device. Contacts are added, deleted, and changed that correspond to the IM application. Furthermore, the presence information of the contacts also change. These changes in both the contacts and the presence information are reflected in corresponding contact entries within the centralized contact store.

### BACKGROUND OF THE INVENTION

An Instant Messenger (IM) program provides a method for a user to send instant messages to other IM users on the Internet or on a network. IM is a type of communications service that enables a user to create a kind of private chat room with another individual in order to communicate in real time over the Internet. IM is analogous to a telephone conversation, but uses text-based, not voice-based, communication. Typically, the instant messaging system alerts a user whenever somebody on the user's private list is online. The user may then initiate a chat session with that particular individual.

With the instant messaging program, a user may perform any number of functions that include viewing the user's contacts who are online, sending an instant message, calling a contact's computer, sending a contact a file, having an instant message conversation with a group of friends, inviting someone to play a game, being notified of new e-mail messages from an e-mail account, and other activities. However, in order to receive the presence information provided by the IM program of who is online, generally a user has the IM application currently running and the IM application being viewed by the user. Additionally, there may be any number of IM client applications present on a computing device. A list of the user's contacts that are present on the network may therefore require that not just the IM client be open and running, but that the correct IM client be open and running that is associated with that contact. Accordingly, a method for providing these contacts along with their presence information in a centralized format is needed.

### SUMMARY OF THE INVENTION

The present invention provides a system and method for synchronizing between an instant messenger (IM) client application and a centralized contact store. The present invention therefore solves the above-mentioned problem by providing the ability to synchronize each of the IM client application contacts with a centralized store of contacts.

When a user logs into the IM client application, the file system containing the contact store is searched to determine if a contact list is present that corresponds to the IM client application. The contact list is a list of the contacts in the contact store that are associated the IM client application. If no contact list exists, one is created. The contacts of the IM application are checked against the contact entries of the contact store as identified by the contact list. When differences exist, whether they are differences corresponding to additional contacts, deleted contacts, changes in the contact information, or changes in presence information of the contacts, the contact entries of the contact store are updated with the update information. Correspondingly, the contacts of the IM application are also updated when changes originate with the contact entries stored in the contact store.

### BRIEF DESCRIPTION OF THE DRAWINGS

FIG. 1 illustrates an exemplary computing device that may be used in one exemplary embodiment of the present invention.

FIG. 2 illustrates an exemplary mobile device that may be used in one exemplary embodiment of the present invention.

FIG. 3 illustrates a block diagram of an exemplary system for synchronizing between an instant messenger (IM) application and a centralized contact store in accordance with the present invention.

FIG. 4 illustrates a block diagram of exemplary data objects created to support synchronizing between an instant messenger (IM) application and a centralized contact store in accordance with the present invention.

FIG. 5 illustrates an exemplary block diagram of a system for synchronizing between an instant messenger (IM) application and a centralized contact store in accordance with the present invention.

FIG. 6 illustrates a logical flow diagram of a process for synchronizing between an instant messenger (IM) application and a centralized contact store in accordance with the present invention.

FIG. 7 illustrates a logical flow diagram of a process for updating the contact entries of the contact store in accordance with the present invention.

### DETAILED DESCRIPTION

The present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

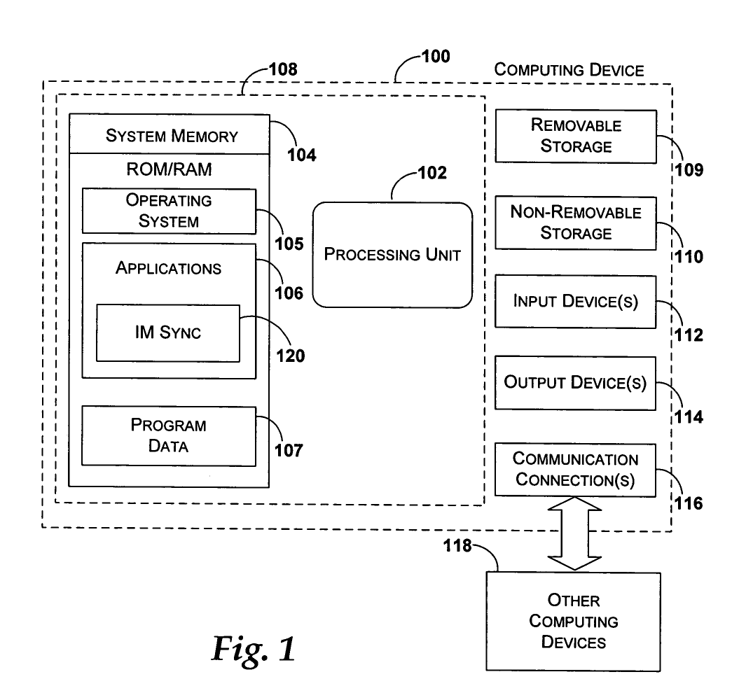

With reference to FIG. 1, one exemplary system for implementing the invention includes a computing device, such as computing device 100. Computing device 100 may be configured as a client, a server, mobile device, or any other computing device that provides client provisioning according to Open Mobile Alliance (OMA) guidelines. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 includes an IM sync application 120 for implementing the functionality of the present invention. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

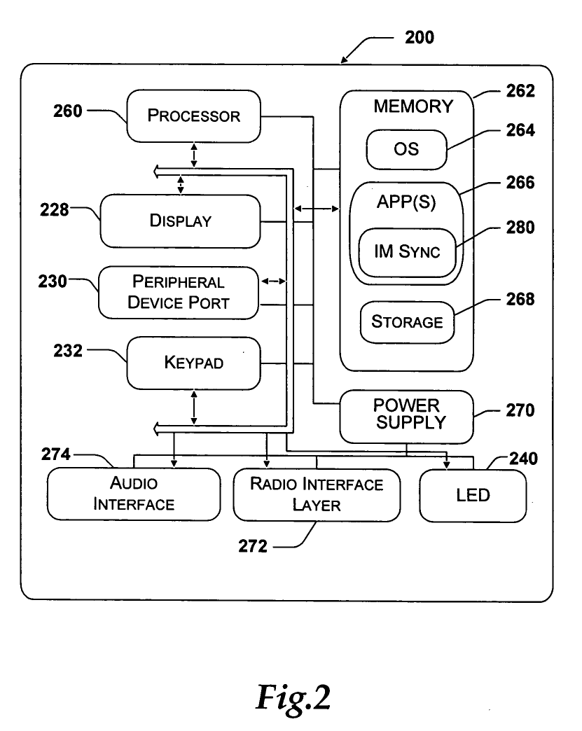

FIG. 2 shows an alternative operating environment for a mobile device substantially for use in the present invention. In one embodiment of the present invention, mobile device 200 is integrated as a computing device, such as an integrated personal digital assistant (PDA) and wireless phone.

In this embodiment, mobile device 200 has a processor 260, a memory 262, a display 228, and a keypad 232. Memory 262 generally includes both volatile memory (e.g., RAM) and non-volatile memory (e.g., ROM, Flash Memory, or the like). Mobile device 200 includes an operating system 264, which is resident in memory 262 and executes on processor 260. Keypad 232 may be a push button numeric dialing pad (such as on a typical telephone), a multi-key keyboard (such as a conventional keyboard), or may not be included in the mobile device in deference to a touch screen or stylus. Display 228 may be a liquid crystal display, or any other type of display commonly used in mobile computing devices. Display 228 may be touch-sensitive, and would then also act as an input device.

One or more application programs 266 are loaded into memory 262 and run on operating system 264. Examples of application programs include phone dialer programs, e-mail programs, scheduling programs, PIM (personal information management) programs, word processing programs, spreadsheet programs, Internet browser programs, and so forth. In one embodiment, application programs 266 include an IM sync application 280 for implementing the functionality of the present invention. Mobile device 200 also includes non-volatile storage 268 within the memory 262. Non-volatile storage 268 may be used to store persistent information which should not be lost if mobile device 200 is powered down. The applications 266 may use and store information in storage 268, such as e-mail or other messages used by an e-mail application, contact information used by a PIM, appointment information used by a scheduling program, documents used by a word processing application, and the like. A synchronization application also resides on the mobile device and is programmed to interact with a corresponding synchronization application resident on a host computer to keep the information stored in the storage 268 synchronized with corresponding information stored at the host computer.

Mobile device 200 has a power supply 270, which may be implemented as one or more batteries. Power supply 270 might further include an external power source, such as an AC adapter or a powered docking cradle that supplements or recharges the batteries.

Mobile device 200 is also shown with two types of external notification mechanisms: an LED 240 and an audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 is used to provide audible signals to and receive audible signals from the user. For example, audio interface 274 may be coupled to a speaker for providing audible output and to a microphone for receiving audible input, such as to facilitate a telephone conversation.

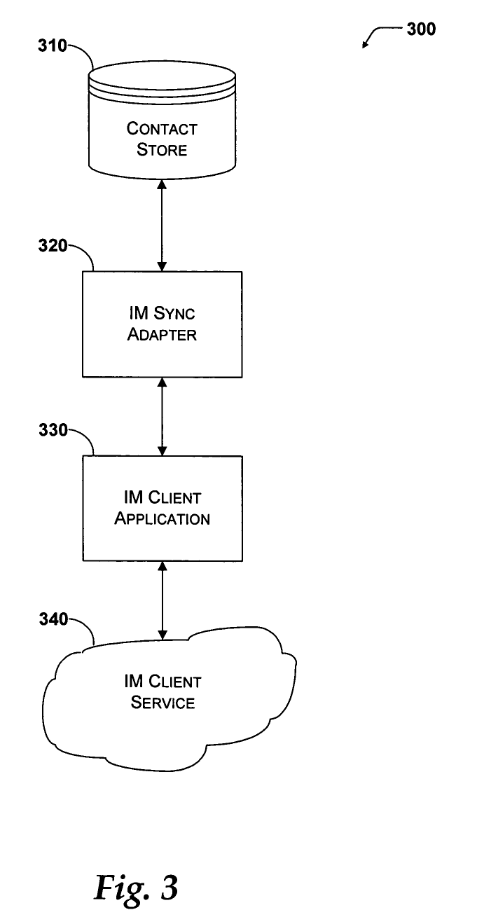

Mobile device 200 also includes a radio 272 that performs the function of transmitting and receiving radio frequency communications. Radio 272 facilitates wireless connectivity between the mobile device 200 and wide area network 340 (FIG. 3), via a communications carrier or service provider. Transmissions to and from the radio 272 are conducted under control of the operating system 264. In other words, communications received by the radio 272 may be disseminated to application programs 266 via the operating system 264, and vice versa.

The radio 272 allows the mobile device 200 to communicate with other computing devices, such as over a network. The radio 272 is one example of communication media.

Synchronizing an IM Client

Throughout the following description and the claims, the contacts store or centralized contacts store may be considered as a portion of a general file system for a computing device. For example, the contacts store may be included in the WINFS file system produced by Microsoft Corporation of Redmond, Wash.

As used herein throughout the specification and the claims, IM client application, IM client, IM provider, and provider are used interchangeably as corresponding to the applications and services that provide the instant messaging service and functionality to the user.

Additionally, despite the following description being made with relation to IM contacts and the presence information provided by an IM service, the present invention is equally applicable to synchronizing between other contact lists (e.g., contacts stored on a cell phone) and a contact store.

FIG. 3 illustrates a block diagram of an exemplary system for synchronizing between an instant messenger (IM) application and a centralized contact store in accordance with the present invention. System 300 includes contact store 310, IM sync adapter 320, IM client application 330, and IM client service 340.

Contact store 310 includes an extensible list of contacts created and maintained for the user of the computing device where contact store 310 is resident. Storing the contacts as part of the local user's central contacts list also allows other applications to take advantage of the information related to that contact. The information includes the presence information provided through the synchronization of the “buddy lists” of the IM clients and contact store 310 in accordance with the present invention. Contact store 310 allows a general contacts user interface to be used for view the local user's list of contacts. By additionally populating contact store 310 with the contacts of the IM buddy lists, the presence of IM contacts is reflected in the general contacts user interface. Other applications (e.g., contact picker dialog) that access contact store 310 are also able to take advantage of the presence information and display a notification of the contacts currently online with one or more the IM providers.

IM sync adapter 320 provides the synchronization protocol for synchronizing the buddy lists of IM client application 330 and contact store 310. The list of contacts associated with IM client application 330 and their presence information may be in a format that is not compatible with the format of contact store 310. IM sync adapter 320 converts the information retrieved from IM client application 330 to a format for presentation within contact store 310. Furthermore, sync adapter 320 provides the functionality for updating the contact list and presence information of contact store 310 when changes occur to the contact list of IM client application 330, while also updating the contact list of IM client application 330 when a change occurs to one or more of the contacts within contact store 310. The operation of sync adapter 320 is described in greater detail below.

IM client application 330 is one of a myriad of IM applications that allow a user to participate in an IM session or other IM related activity. IM client service 340 is the remote service that updates the presence of the contacts currently logged in and available to initiate an IM session. In general, the IM service used is dependent upon the IM client application. However, for the purposes of the present invention, any IM service may be providing the updated presence information for the contact list of IM client application 330.

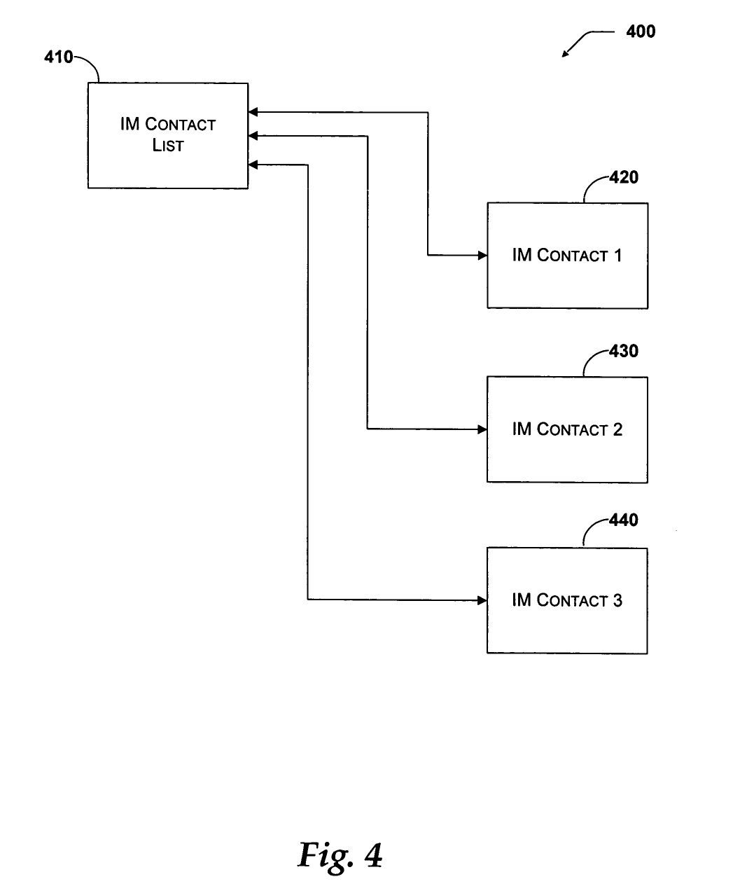

FIG. 4 illustrates a block diagram of exemplary data objects created to support synchronizing between an instant messenger (IM) application and a centralized contact store in accordance with the present invention. The exemplary data objects include an IM contact list 410 and IM contact entries 420, 430, 440.

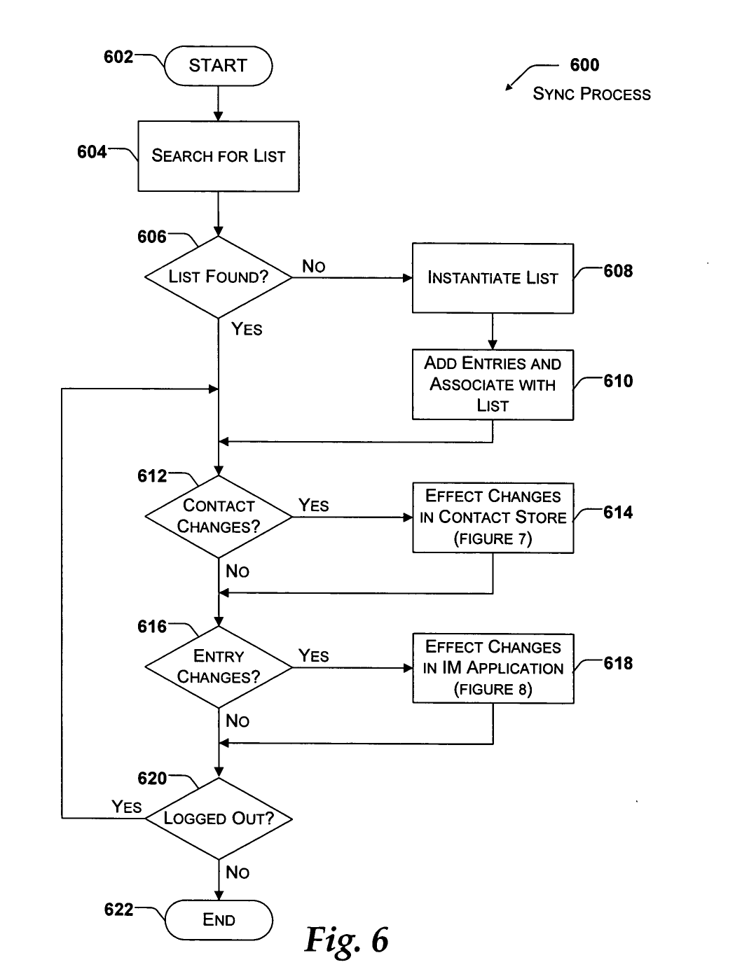

IM contact list 410 is a list object that is created to associate contact entries (e.g., 420) with a particular IM client application (see FIG. 3). When an IM client application is activated by the user, the contact store is updated with the contacts associated with the IM client application. If the contact store does not already include these contact entries, then these entries from the IM application are transferred to the contact store. Alternatively, certain contact entries (e.g., 420) may already be included in the contact store, then the contact store is updated with the entries not included. The algorithm for updating the contact store is discussed in greater detail below with relation to FIG. 6. IM contact list 410 associates each of the contact entries with a particular contact store, so that changes to contact list in the associated IM application are reflected in the correct contact entries of the contact store. For example, if the user selects not to have the IM contacts of a particular IM application reflected in the contact store, then the list object allows the associated contacts to be easily removed due to their association with the list object. Each list object includes pointers to their associated contact entries in the contact store, allowing these contact entries to be manipulated and organized according to their lists.

IM contact entries 420, 430, and 440 are entries similar to the entries already included in the contact store authored by the user or generated in association with another type of program (e.g., an email application). In addition, IM contact entries 420, 430, and 440 also include presence information (e.g., whether a contact is currently online or offline with a specified IM provider) that may be present to the user when viewing the contact. IM contact entries 420, 430, 440 may be associated with one or more of the IM contact lists. For example, a particular contact may be a contact that is associated with one or more IM applications. Accordingly, the IM contact list objects associated with the IM applications each include a pointer to the same IM contact entry (e.g., 420). The relationship between the IM contact list and its associated IM contact entries is an “is member of” type of relationship, such that each entry may be considered a member of the lists with which it is associated.

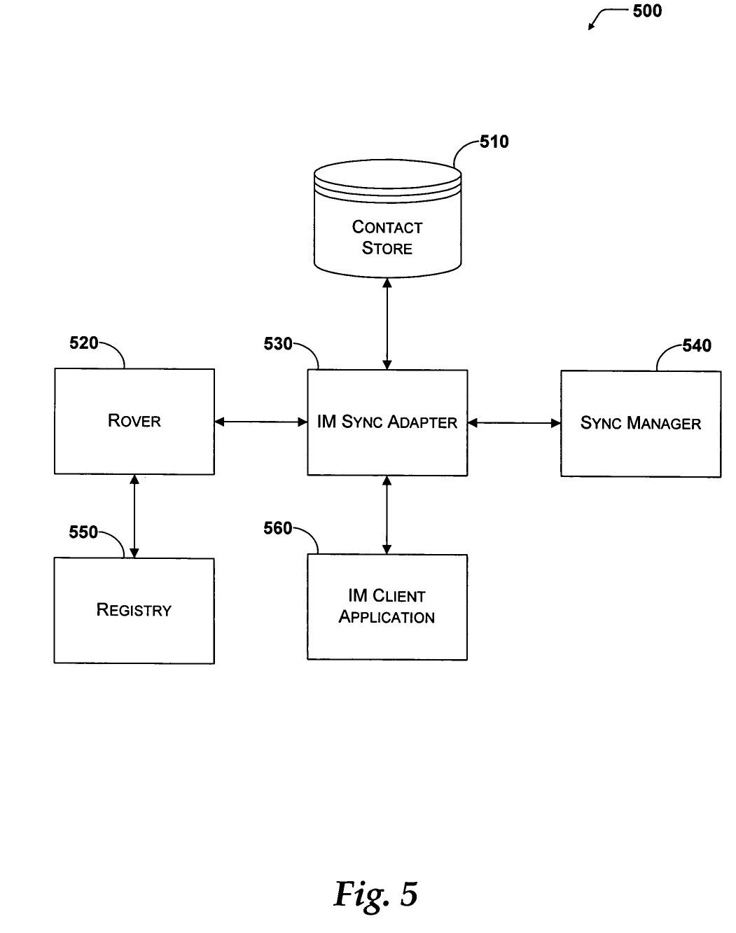

FIG. 5 illustrates an exemplary block diagram of a system for synchronizing between an instant messenger (IM) application and a centralized contact store in accordance with the present invention. System 500 includes contact store 510, rover 520, IM sync adapter 530, Sync manager 540, registry 550, and IM client application 560.

Contact store 510 is similar to contact store 310 shown in FIG. 3 and is used to store the contact entries for a user in a centralized location. Contact store 510 allows a host of applications to access and use the contact and presence information published under the contact store 510 structure.

Rover 520 loads IM sync adapter 530 along with other client application adapter for communicating between these applications and the file system containing contact store 510.

IM sync adapter 530 is similar to IM sync adapter 320 shown in FIG. 3 and is used as an interface to synchronize between IM client application 560 and contact store 510.

Sync manager 540 is a component that manages the sync adapters running on the computing device. Sync manager 540 provides for monitoring of the sync adapters currently running on the computing device and their state.

Registry 550 contains the list of providers that are to be instantiated by rover 520 for synchronization with contact store 510.

System 500 is exemplary only of some of the components that may be included for implementing the present invention. Other components and other system structures may be used without departing from the spirit or scope of the invention.

FIG. 6 illustrates a logical flow diagram of a process for synchronizing between an instant messenger (IM) application and a centralized contact store in accordance with the present invention. Process 600 starts at block 602 where the user has signed into an IM account associated with a particular IM service. Processing continues at block 604.

At block 604, the file system containing the contact store is searched to determined whether one or more IM contact lists exist that correspond to the user's IM account. In one embodiment, each IM contact list includes an identifier that correlates the list with a particular IM client application. If the identifier corresponds to the IM account on which the user has logged in, then the IM contact list is identified as corresponding to the active IM client application. Processing continues at decision block 606.

At decision block 606, a determination is made whether the search for the list was successful and an IM contact list corresponding to the active IM application is found. One example when a corresponding list may not be located is when the user is logging into the particular IM service for the first time. If a corresponding IM contact list is found, processing advances to decision block 612. However, if a corresponding IM contact list is not found, processing moves to block 608.

At block 608, an IM contact list to correspond to the active IM application is instantiated for associating contacts with the active IM application. The IM contact list is further described above with relation to FIG. 4. Processing continues at block 610.

At block 610, contact entries are added to the contact store for each of the contacts associated with the active IM application. As each entry is added to the contact store, it is associated with the IM contact list corresponding to the IM application. When each new entry has been added and the associations have been made, processing continues at decision block 612.

At decision block 612, a determination is made whether any changes have occurred to the contacts of the IM client application that should be reflected in the contact entries of the contact store. The changes that may have occurred include added contacts, deleted contacts, changes in presence information, changes in contact information, and other changes. If changes have not occurred to the contacts of the IM client application, then processing advances to decision block 616. However, if changes have occurred, processing moves to block 614.

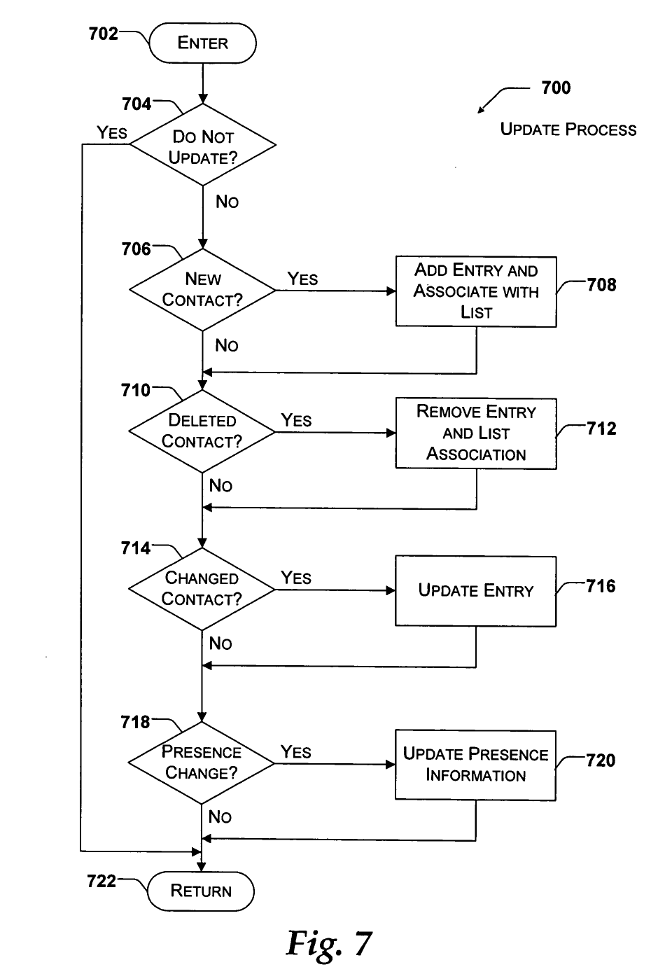

At block 614, the contact entries of the contact store are updated with the changes that have occurred to the corresponding contacts associated with the IM client application. The process for updating the contact entries of the contact store is described in greater detail with relation to FIG. 7 below. Processing continues at decision block 616.

At decision block 616, a determination is made whether changes have occurred to the contact entries of the contact store that are associated with the active IM client application and that may be reflected in the contact list or buddy list of the IM client application. The changes that may have occurred include added contacts, deleted contacts, changes in contact information, and other changes. If changes have not occurred to the contacts entries of the contact store, then processing advances to decision block 620. However, if changes have occurred, processing moves to block 618.

At block 618, the contact list or buddy list associated with the IM client application is updated with the changes that occurred to the corresponding contact entries of the contact store. The process for updating the contacts list of the IM client application is similar to the process for updating the contact entries of the contact store shown in FIG. 7 below. However, the presence information is provided to the contact store from the IM client application, and therefore the IM client application is not updated with such information from the contact store. However, the other changes that occur, such as added contacts, deleted contacts, and changes in the contact information (e.g., phone number change) may be updated in the IM application based on the contact store. Furthermore, the list associations described in FIG. 7 below do not apply to the contact list of the IM client applications as described for the present invention. Processing continues at decision block 620.

At decision block 620, a determination is made whether the user has logged out of the IM client application being synchronized. If the user has not logged out, processing returns to decision block 612 where process 600 continues to monitor for changes in the contacts of both the IM client application and the contact store. However, if the user has logged out, processing continues at block 622, where process 600 ends.

Throughout process 600 and the following processes shown in FIGS. 7 and 8, the user may choose to log out of the IM client application at any time. Furthermore, crashes, losses of network connections, and other unplanned events may occur that may affect the synchronization process. In one embodiment, when the user has logged out of the IM client application, each of the contacts in the contact store corresponding to the IM client application are updated so that the presence of each of these contacts is shown as offline. In another embodiment, when a crash occurs or other unplanned event that severs the synchronization process, the presence information of the related contacts is again defaulted to offline.

FIG. 7 illustrates a logical flow diagram of a process for updating the contact entries of the contact store in accordance with the present invention. Process 700 enters at block 702 when process 600 shown in FIG. 6 enters block 614. Processing continues at decision block 704.

At decision block 704, a determination is made whether the user has selected to not have the contact entries of the contact store updated with the changes to the contacts of the IM application. If the user has selected this option, then process 700 is skipped and processing advances to block 722 where processing returns to decision block 616 of process 600 shown in FIG. 6. Otherwise, this option has not been selected by the user and processing continues at decision block 706.

At decision block 706, a determination is made whether a new contact has been added to IM client application. If no new contacts have been added to the buddy list of the IM client application, then processing advances to decision block 710. However, if any new contacts have been added to the buddy list of the IM client application, then processing moves to block 708.

At block 708, a new contact entry or contact object is added to the contact store that corresponds to the new contact in the buddy list. The new contact entry includes all the applicable contact information that is included in the contact of the buddy list. Once the new entry is created, the “is member of” association of the contact entry is made with the corresponding IM contact list. Along with the contact information being supplied to generate the new contact entry in the contact store, the presence information for that contact is also supplied. In one embodiment, the presence information may be displayed through an icon or other visual indicator when the contact is view through a selected user interface. Once the new contact entries for the new contacts have been generated, and the list associations made, processing continues at decision block 710.

At decision block 710, a determination is made whether a contact, previously synchronized with the contact store, has been deleted from the buddy list of the IM client application. If no synchronized contacts have been deleted, then processing advances to decision block 714. However, if a previously synchronized contact has been deleted, then processing moves to block 712.

At block 712, the contact entries of the contact store that have been deleted from the buddy list of the IM client application are removed. Furthermore, the relationship between each removed contact entry and the IM contact list associated with the IM client application is also removed. Processing then continues at decision block 714.

At decision block 714, a determination is made whether a change has occurred to the information contained within a contact associated with the IM client application. For example, a phone number associated with the contact may have changed. In one embodiment, each contact associated with the IM client application is compared to each contact entry of the contact store. Changes have occurred when a difference between the data entry field of the contact of the IM application and the contact entry of the contact store are detected. If no such changes to the contacts of the IM client application have occurred, then processing advances to decision block 714. However, if such a change has occurred, processing moves to block 716.

At block 716, the contacts for which changes have occurred are updated with those changes. In one embodiment, updating the contact entry with the changes involves an “add” operation rather than a “replace” operation. Stated by way of example, a contact's phone number may be different in the buddy list of the IM client when compared to the contact entry of the contact store. Determining which phone number is the correct number involved more processing, so the phone number is instead added to the list of phone numbers for the contact, rather than replacing a phone number. Using an “add” operation preserves both phone numbers and allows the user to make the determination which is correct. Once the entries have been updated, processing continues at decision block 718.

At decision block 718, a determination is made whether the presence information for each of the contacts associated with the IM client application have changed. As various users change their online status with a particular IM service, the IM presence information for those contacts correspondingly change. In one embodiment, the IM client application receives presence update events from the IM provider that indicates a change in a contact's presence on the network. The presence update event includes an identifier of the contact and the new presence status of the contact. The present update event is forwarded to the file system containing the contact store. In response to the presence update event, the contact entry in the contact store is updated with the new presence status of the contact. In one embodiment, the presence of a contact may be considered as too old, or expired. If the presence data used to update a contact in the contact store is considered too old it is not used to update the contact entry. If the presence information of the contacts of the IM client application have not changed, processing continues to block 722, where processing returns to decision block 616 of process 600 shown in FIG. 6. However, if changes have occurred to the presence information of the contacts, processing moves to block 720.

At block 720, the presence information supplied by the IM provider to the IM client application is used to update the presence information of the contact entries in the contact store. As previously stated, the update may be manifested as a change of an icon or other indicator of the presence of the contact on the network. Once the presence information has been updated, processing continues at block 722, where processing returns to decision block 616 of process 600 shown in FIG. 6.

As previously mentioned, process 700 is similarly applicable to updating the buddy list of the IM client application based on the contacts of the contact store with the exceptions of supplying presence information and list associations.

The contact store may already contain a contact entry for a particular contact when the same contact is also discovered to correspond to a contact within the buddy list of an IM client application. In one embodiment, the contact entries are combined into a single contact entry with an association to the corresponding IM contact list. In another embodiment, two separate entries are maintained.

In further embodiments, despite the present discussion focusing on IM client applications, the method of the present invention may be used to synchronize other contacts with a centralized contact store.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for synchronizing contacts of an instant messenger client application with a central contact store, comprising:
obtaining the contacts from the instant messenger client application when a user instantiates the instant messenger client application; and
updating the central contact store according to the contacts obtained from the instant messenger client application, such that changes in each contact are reflected in corresponding contact entries of the central contact store.

2. The computer-implemented method of claim 1, further comprising updating the contacts of the instant messenger client application according to the central contact store, such that changes in each contact entry of the central contact store are reflected in contacts of the instant messenger client application.

3. The computer-implemented method of claim 1, wherein updating the central contact store further comprises searching for a list of contacts associated with the central contact store that identifies contact entries in the central contact store as corresponding to the instant messenger application.

4. The computer-implemented method of claim 3, wherein a new list of contacts is instantiated when the list of contacts is not found.

5. The computer-implemented method of claim 3, wherein a relationship is established between the contact list and each contact entry corresponding to a contact associated with the instant messenger client application, wherein the relationship indicates that the contact entry is a member of the contact list.

6. The computer-implemented method of claim 1, wherein updating the central contact store further comprises adding new contact entries to the central contact store in response to new contacts being added to the contacts of the instant messenger client application.

7. The computer-implemented method of claim 1, wherein updating the central contact store further comprises removing contact entries in the central contact store in response to deletion of contacts of the instant messenger client application.

8. The computer-implemented method of claim 1, wherein updating the central contact store further comprises determining whether difference exist between a first data fields of a contact entry in the central contact store and a second data field corresponding contact of the instant messenger application.

9. The computer-implemented method of claim 8, wherein the first data field and second data field are both retained with a difference exists between the first and second data fields.

10. The computer-implemented method of claim 1, wherein updating the central contact store further comprises updating the contact entries of the central contact store in response to a change in the presence information for corresponding contacts of the instant messenger application.

11. A system for synchronizing contacts of an instant messenger client application with a central contact store, comprising:
a rover; and
a sync adapter that is instantiated by the rover, wherein the sync adapter is configured to:
obtain the contacts from the instant messenger client application when a user instantiates the instant messenger client application; and
update the central contact store according to the contacts obtained from the instant messenger client application, such that changes in each contact are reflected in corresponding contact entries of the central contact store.

12. The system of claim 11, wherein the sync adapter is further configured to update the contacts of the instant messenger client application according to the central contact store, such that changes in each contact entry of the central contact store are reflected in contacts of the instant messenger client application.

13. The system of claim 11, wherein updating the central contact store further comprises searching for a list of contacts associated with the central contact store that identifies contact entries in the central contact store as corresponding to the instant messenger application.

14. The system of claim 13, wherein a relationship is established between the contact list and each contact entry corresponding to a contact associated with the instant messenger client application, wherein the relationship indicates that the contact entry is a member of the contact list.

15. The system of claim 11, wherein updating the central contact store further comprises determining whether difference exist between a first data fields of a contact entry in the central contact store and a second data field corresponding contact of the instant messenger application.

16. The system of claim 15, wherein the first data field and second data field are both retained with a difference exists between the first and second data fields.

17. The system of claim 11, wherein updating the central contact store further comprises updating the contact entries of the central contact store in response to a change in the presence information for corresponding contacts of the instant messenger application.

18. A computer-readable medium that includes computer-executable instructions for synchronizing contacts of an instant messenger client application with a central contact store, the instructions comprising:
obtaining the contacts from the instant messenger client application when a user instantiates the instant messenger client application; and
updating the central contact store according to the contacts obtained from the instant messenger client application, such that changes in each contact are reflected in corresponding contact entries of the central contact store;
updating the contacts of the instant messenger client application according to the central contact store, such that changes in each contact entry of the central contact store are reflected in contacts of the instant messenger client application.

19. The computer-readable medium of claim 18, wherein updating the central contact store further comprises searching for a list of contacts associated with the central contact store that identifies contact entries in the central contact store as corresponding to the instant messenger application.

20. The computer-readable medium of claim 18, wherein updating the central contact store and updating the contacts of the instant messenger client application each further comprises determining whether difference exist between a first data fields of a contact entry in the central contact store and a second data field corresponding contact of the instant messenger application.

21. The computer-readable medium of claim 20, wherein the first data field and second data field are both retained with a difference exists between the first and second data fields.

22. The computer-readable medium of claim 18, wherein updating the central contact store further comprises updating the contact entries of the central contact store in response to a change in the presence information for corresponding contacts of the instant messenger application.
